(19) United States
(12) Patent Application Publication
(10) Pub. No.: US 2023/0122230 A1
(43) Pub. Date: Apr. 20, 2023

(54) INTEGRATED PLANT FOR REFUSE INCINERATION AND FOR PRODUCING ROCK WOOL, AND METHOD FOR OPERATING THE PLANT

(71) Applicants: GRENZEBACH BSH GMBH, Bad Hersfeld (DE); PETRURGIA EOOD, Sofia (BG)

(72) Inventors: Maik ULRICH, Bad Hersfeld (DE); Todor TODOROV, Sofia (BG); Roumen GAITANSKI-YOUNG, Sofia (BG)

(73) Assignees: GRENZEBACH BSH GMBH, Bad Hersfeld (DE); PETRURGIA EOOD, Sofia (BG)

(21) Appl. No.: 17/909,535

(22) PCT Filed: Mar. 3, 2020
(86) PCT No.: PCT/EP2020/000055

§ 371 Date: Sep. 6, 2022

(51) Int. Cl. F23G 5/46; F23G 5/00; C03B 5/00; C03B 5/02; C03B 37/04

(52) U.S. Cl. CPC F23G 5/46; F23G 5/006; C03B 5/005; C03B 5/02; C03B 37/04; F23G 2206/203; F23G 2206/201; F23J 2700/003

(57) ABSTRACT

A refuse incineration plant with an incineration device for generating steam, at least one downstream steam turbine with electricity generator for generating electric current, and for generating refuse products. Electricity, steam, processed refuse products of the refuse incineration plant, processed, fusible rock or rock mixture and processed refuse fibres and dusts are used to operate a rock wool production plant, the refuse heat and exhaust air being fed to the combustion device of the refuse incineration plant.

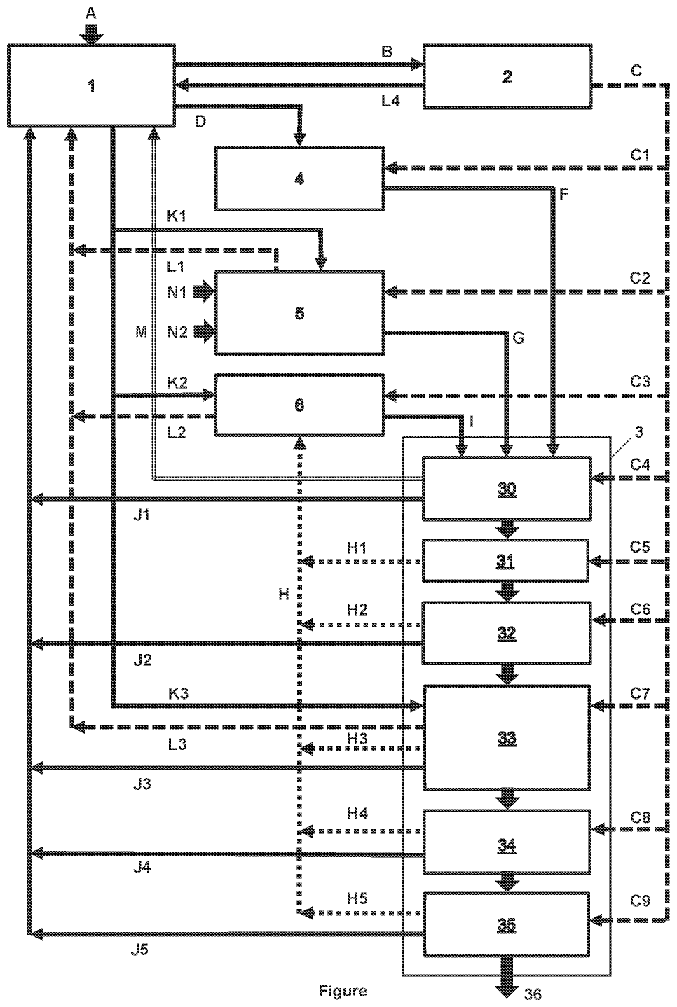

The invention relates to a refuse incineration plant with a combustion device for generating steam, at least one downstream steam turbine with an electricity generator for generating electric power, and for generating refuse products. Electricity, steam, processed refuse products from the refuse incineration plant, processed fusible rock or rock mixture, and processed refuse fibres and dusts are used to operate a rock wool production plant, the refuse heat and exhaust air of which are supplied to the combustion device of the refuse incineration plant. The invention thus relates to an integrated refuse incineration and rock wool production plant and a method of operating the plant.

Wastes of industrial goods made of composite materials, such as motor vehicles and household appliances, but also oils, batteries, varnishes, paints, toxic sludges, medicines and hospital refuse are subject to separate disposal measures strictly prescribed by law. Household refuse, on the other hand, is an uncontrolled heterogeneous mixture that can contain almost all kinds of hazardous refuse fractions and organic components, the disposal of which is disproportionate to its environmental impact.

In landfills, domestic refuse is stored inadequately, digester gases and carbon dioxide escape uncontrollably into the atmosphere, and pollutant-containing liquids and eluates from the landfilled refuse contaminate the groundwater.

In order to reduce the amount of refuse to be treated, it has already been proposed to compost the organic components from household refuse and sewage sludge. This ignores the fact that these contain a large number of heterogeneous organic substances and a large number of non-degradable toxic components such as chemicals, pharmaceutical and heavy metal residues, which remain in the compost and are returned to the biological cycle via plants and animals.

By recycling so-called recyclable materials, attempts are also being made to reduce the amount of refuse. The high costs of separate collection and processing of these wastes remain unnoticed; with repeated recycling, costs and environmental pollution increase with reduced usability of the products obtained.

Refuse disposal methods are based on the classical open refuse incineration in so-called grate furnaces, whereby attempts are sometimes made to convert the incineration residues, i.e. the incombustible solid residues and heavy metals, into an environmentally compatible form (cf. “Müll and Abfall”, issue 2/89, pages 64 to 70).

In the known refuse incineration plants, the disposal materials pass through a wide temperature field, and a large proportion of the materials introduced are incinerated. Despite the high technical effort in the known state of the art, about 40% of the refuse to be disposed of remains after incineration in the form of ashes and slags, which have to be disposed of at high cost. In order to reduce the volume to be landfilled, it is known to separate the metallic components of the residues and to recycle them separately.

From EP 0 520 086 A2, a process for the utilisation of refuse is known, in which refuse is thermally treated and fed to a complete material conversion. According to this process, unsorted refuse of all kinds, possibly containing a large number of toxic components, is converted into liquid form by means of high-temperature treatment and discharged and further treated accordingly.

U.S. Pat. No. 4,957,049 A discloses a refuse incineration plant in connection with a steam turbine which uses the steam produced during refuse incineration to generate electricity.

It is the object of the present invention to provide an integrated plant for refuse incineration and for producing rock wool which is even more efficient than a single refuse incineration plant and a single rock wool production plant according to the respective prior art. According to the invention, this object is resolved as disclosed by claim 1.

An advantage of the invention is that thermal and electrical energy are utilised in the same way.

Through the coupled process of producing rock wool, it is possible to simultaneously use and process the heat of the exhaust air from the rock wool producing process thermally in the refuse incineration plant. Pollutants are rendered thermally harmless while the heat content of the exhaust air is utilised.

Refuse is fed into the incinerator, for example, as is known from EP 0661 368 A1, although the present invention is preferably directed to the disposal of domestic refuse. High disposal capacities are achieved even with a small plant design, without the need for cost-intensive pre-treatment processes, such as separate collection and technically complex processing, shredding, separating, drying and briquetting. The resulting refuse products are subjected to a crushing and mixing process. They are then fed into a melting furnace.

The combustion process in the incinerator produces sufficient steam to operate a steam turbine, which generates electrical power, which is then used again to operate, in particular, the electric melting furnace, an electric heater of the curing furnace if necessary, and all the electric drives of the rock wool production plant.

Similarly, it is also advantageous if exhaust air from the melting furnace, the collecting chamber, the curing furnace, the cooling zone and the sawing device is used to feed it respectively to the refuse incineration device.

According to the invention, a meltable rock or a rock mixture for producing so-called rock wool insulating materials is fed to a furnace, which is usually designed as an electric melting furnace.

Advantageously, the meltable rock or the rock mixture is first fed to a raw material preparation plant for drying and/or preheating and from there fed into the melting furnace. Preferably, the refuse heat from the combustion device is fed to the raw material preparation plant. Equally, however, the refuse heat from the combustion device can also be fed to a plant for processing fibre refuse and dust in order to dry them.

According to DIN 4102, part 17, the fusible rock or rock mixture must have a melting point of more than 1000° C. Insulating materials made of rock wool is produced exclusively from rocks such as diabase or basalt, whereby limestone and/or dolomite is added as corrective aggregates. These aggregates can also be completely or partially replaced by blast furnace slags and/or other slags from the iron industry.

In addition to the fusible rocks or rock mixtures, the refuse products from the refuse incineration plant can also be fed at least partially to the electric melting furnace and fused together to form a uniform fused product, which is fed to a spinning machine, The spinning process produces rock wool.

Likewise, advantageously, fibre refuse from the spinning machine and the collection chamber, as well as dust from the curing oven, the cooling zone and the sawing device, are fed to a treatment facility, from where they are returned to the melting furnace. Preferably, steam from the refuse incinerator is supplied to the treatment device for drying the fibre refuse and dust.

Preferably, the curing oven is at least largely operated with steam originating from the refuse incineration facility.

Another advantage of the invention is that the refuse incineration plant comprises a boiler, for example a steep-tube boiler, which is in turn equipped with a heat exchanger and which receives preheated boiler feed water from a jacket cooling device of the electro-melting furnace. Cooling water flows through the jacket cooling device of the electro-melting furnace, which in turn is heated by the cooling process and is then supplied to the refuse incineration plant as boiler feed water.

A further advantage of the invention is that, in contrast to known coke cupola furnaces, no additional carbon dioxide is produced by the rock wool producing process by electric melting furnaces.

Advantageous further embodiments of the invention will be apparent from the dependent claims and the following description, in particular in conjunction with the drawing.

The invention is explained in more detail below with reference to the drawing. The single FIGURE shows a schematic view of a refuse incineration plant comprising an incineration device coupled to a rock wool production plant.

A refuse incineration plant comprises an incineration device 1 (FIGURE) in which, for example, household refuse is incinerated, which is fed to the device 1 in the direction of an arrow A. The device 1 is designed to incinerate household refuse. However, this does not exclude that any other forms of refuse, in particular refuse from certain industries, are also or alternatively used in certain embodiments of the incineration device 1.

Steam generated during the incineration of refuse is fed in the direction of an arrow B to a plant 2 for generating electricity. The plant 2 comprises, for example, turbines which are driven by the steam. The electricity generated in plant 2 is fed in the direction of an arrow C primarily to a plant 3 for producing rock wool. Via a line L4, the condensate produced by the cooling of the steam in the plant 2 is returned to a heat exchanger of the device 1. The plant 2 supplies electricity to a plurality of aggregates and equipment within the entire refuse incineration plant.

Plant 3 comprises an electric melting furnace 30, a spinning machine 31, a collecting chamber 32, a curing furnace 33, a cooling zone 34 and a sawing line 35, each downstream of the other. Each one of the units 30 to 35 preferably receives electricity from the plant 2, as indicated in the figure by the arrows C4 to C9.

On the other hand, the device 1 produces refuse products as combustion products in the form of ash or slag, which are fed in the direction of an arrow D to a plant 4 for processing these refuse products. In plant 4, the refuse products are crushed and mixed, preheated and dried. Plant 4 also preferably receives electricity from plant 2 via a line C1. The refuse products produced in plant 4 are fed to melting furnace 30 in the direction of an arrow F.

Rocks, for example basalt and dolomite or basalt and blast furnace slag, are fed to a plant 5 for raw material preparation via conveyor belts N1 and N2, respectively, and then fed in dried and preheated form in the direction of an arrow G to the electric melting furnace 30, from which liquefied rock is fed to the spinning machine 31. In this spinning machine, rock fibres are spun and fed into the collecting chamber 32. From here they pass into the hardening furnace 33, after which they are cooled again in the cooling zone 34; and in the sawing line 35 blocks produced from the rock fibres are sawn to suitable dimensions. Plant 5 receives power from plant 2 via a line C2. Via a line M, electric melting furnace 30 is connected to equipment 1 for feeding preheated boiler feed water into the boiler of device 1.

Fibre refuse produced in the spinning machine 31 and in the collecting chamber 32 and dust produced in the curing oven 33, the cooling zone 34 and the sawing line 35 are fed in the direction of an arrow H via lines H1 to H5 to a plant 6 for processing fibre refuse and for processing dust. From this plant, the dried mixture of fibres and dust is fed in the direction of an arrow I to the electric melting furnace 30. Plant 6 receives electricity from plant 2 via line C3.

Exhaust air from the electric melting furnace 30, the collecting chamber 32, the curing furnace 33, the cooling zone 34 and the sawing line 35 is returned to the device 1 in the direction of arrows J1, J2, J3, J4 and J5, respectively,

On the other hand, refuse heat in the form of steam is fed from the device 1 in the direction of an arrow K1 to the plant 5 for raw material preparation and in the direction of an arrow K2 to the plant 6 for fibre refuse preparation and dust preparation. Similarly, steam is also supplied to the curing oven 33 from the device 1 via a line K3, so that it is operated with steam. When cooled, the steam is returned to the device 1 as condensate from the plants 5, 6 and the curing oven 33 via lines L1, L2 and L3.

Thus, the overall plant according to the invention shown in the FIGURE forms a combination of various units for integrated refuse heat and refuse product utilisation in the conversion of refuse to electricity and the simultaneous production of rock wool 36 as the end product of the rock wool production plant. The spatial proximity reduces heat losses. Exhaust air generated during producing the rock wool is returned to the refuse incineration device 1. On the other hand, the educts of device 1 in the form of steam, refuse heat and refuse products are reused as completely as possible. In this way, it is possible to link the refuse incineration with the production of rock wool in dose spatial proximity in order to thereby achieve an output of rock wool that is optimised in terms of energy.

As far as necessary, however, additional energy is supplied to plant 3 if this is required for the use of raw materials which, for example, require a post-treatment time in the form of additional melting time.

The power plant combustion in the device 1 is used for post-combustion of pollutants occurring in the exhaust air of the rock wool manufacturing process.

An advantage of the device according to the invention is that it does not require any fossil energy sources for energy generation in addition to the energy content contained in the refuse.

1. A refuse incineration plant with an incineration device for generating steam, which is fed to at least one steam turbine, and for generating refuse products, wherein
the refuse products is fed at least partially together with a meltable rock or rock mixture to a melting furnace, rock material melted in the melting furnace is fed to a spinning machine and rock wool is produced by the spinning process.

2. The refuse incineration plant according to claim 1, wherein
the rock or the rock mixture is fed to a raw material processing plant for drying and/or preheating and is fed from the raw material processing plant to the melting furnace.

3. The refuse incineration plant according to claim 2, wherein
refuse heat from the incineration device is fed to the raw material preparation plant.

4. The refuse incineration plant according to claim 1, wherein
steam is generated in the incineration device, which steam is fed to at least one installation for generating electricity.

5. The refuse incineration plant according to claim 4, wherein
the electricity generated by the at least one steam turbine is fed to the melting furnace, which is designed as an electric melting furnace.

6. The refuse incineration plant according to claim 4, wherein,
steam condensate is fed back from the at least one installation for generating electricity to a boiler of the incineration device.

7. The refuse incineration plant according to claim 1, wherein
a collecting chamber, a curing oven, a cooling zone and a sawing device are arranged downstream of the spinning machine for producing a rock wool product.

8. The refuse incineration plant according to claim 7, wherein
exhaust air from the melting furnace, the collecting chamber, the hardening furnace, the cooling zone and the sawing device, respectively, is fed to the refuse incineration device.

9. The refuse incineration plant according to claim 8, wherein
fibre refuse from the spinning machine and the collecting chamber and dust from the curing oven, the cooling zone, and the sawing device, respectively, are fed to a processing plant for processing fibre refuse and dust and is fed from the latter to the melting furnace.

10. The refuse incineration plant according to claim 9, wherein
refuse heat from the refuse incineration plant is fed to the processing device for processing the raw material and/or to a drying plant for drying fibre refuse and for processing dust.

11. The refuse incineration plant according to claim 1, wherein
basalt rock, is fed to the raw material processing plant.

12. The refuse incineration plant according to claim 1, wherein
steam condensate from the raw material preparation plant, from the drying plant and from the hardening furnace is returned to the boiler of the incineration device.

13. The refuse incineration plant according to claim 1, wherein
boiler feed water is fed from a cooling device of the melting furnace to a boiler in the incineration device.

14. A method for burning refuse in a refuse incineration plant with a combustion device for generating refuse products and steam which is fed to at least one steam turbine, wherein,
the refuse products are at least partially fed to a melting furnace together with a meltable rock or rock mixture, and rock material is melted in the melting furnace and fed to a spinning machine for spinning rock wool.

15. The method according to claim 14, wherein
electricity is generated by the at least one steam turbine which heats the melting furnace designed as an electric melting furnace.

16. The method according to claim 14, wherein
refuse heat from the combustion device is supplied to a processing plant for processing rock or a rock mixture and/or to a drying plant for drying fibre refuse and for processing dust.

17. The method according to claim 14, wherein
exhaust air is supplied from the melting furnace, from a collecting chamber arranged downstream of the spinning machine, from a curing furnace, from a cooling zone and/or from a sawing device.
